(19) United States
(12) Patent Application Publication
(10) Pub. No.: US 2026/0177752 A1
(43) Pub. Date: Jun. 25, 2026

(54) OPTICAL CONNECTOR, OPTICAL MODULE, AND METHOD FOR EVALUATING OPTICAL CONNECTOR

(71) Applicant: Enplas Corporation, Saitama (JP)

(72) Inventors: Yuki AOKI, Saitama (JP); Satoshi OSHIMA, Saitama (JP); Masaaki SAITO, Saitama (JP)

(21) Appl. No.: 18/836,114

(22) PCT Filed: Feb. 1, 2023
(86) PCT No.: PCT/JP2023/003270

§ 371 Date: Aug. 6, 2024

(30) Foreign Application Priority Data
Feb. 10, 2022 (JP) 2022-019615

(51) Int. Cl. G02B 6/36; G02B 6/38

(52) U.S. Cl. CPC G02B 6/3616; G02B 6/3636; G02B 6/3838; G02B 6/385; G02B 6/3851

(57) ABSTRACT

The present invention relates to provide an optical connector that is easy to evaluate if it is manufactured as designed. An optical connector according to the present invention comprises: a light transmission wall including a first surface and a second surface; and a holding part for holding an optical transmission body. The optical connector has, on the first surface, a plurality of first optical surfaces disposed along an X direction, a plurality of grooves disposed in the holding part and extending in a direction opposite to the first surface so as to go away from the second surface, and a plurality of X-direction reference marks. Each of the plurality of X-direction reference marks is disposed on a first virtual plane including a valley line of any groove of the plurality of grooves and perpendicular to the X direction.

### TECHNICAL FIELD

The present invention relates to an optical connector, an optical module, and a method for evaluating the optical connector.

### BACKGROUND ART

An optical connector is known in which an optical transmission member (such as an optical fiber and an optical waveguide) is disposed to receive light from the optical transmission member. The optical connector is configured to be able to set the end portion of the optical transmission member at an appropriate position.

For example, PTL 1 discloses an optical connector including a clad part where an optical waveguide is formed, and a lens provided at a position facing the end surface of the optical waveguide.

### CITATION LIST

### Patent Literature

### PTL 1

Japanese Patent Application Laid-Open No. 2009-168850

### SUMMARY OF INVENTION

### Technical Problem

In an optical connector as that disclosed in PTL 1, it is important to correctly align the end surface of the optical transmission member with respect to the optical connector. Normally, the optical connector is designed such that the optical transmission member is disposed at a correct position when the optical transmission member is held at the holding part of its optical transmission member.

However, such alignment requires high positional accuracy. Therefore, if the optical connector is not highly accurately manufactured as designed, such as if it has a slight deformation, the optical transmission member may not be correctly aligned. In view of this, it is necessary to evaluate if the optical connector is highly accurately manufactured as designed.

As such an evaluation method, it is conceivable to employ the following method, for example. Specifically, whether the optical connector is manufactured as designed is evaluated by measuring a V groove where the optical transmission member is disposed with a three-dimensional measuring device, calculating the center of a virtual circle inscribed in the V groove, and evaluating the positional relationship between the center of the circle and the center of the lens surface of the optical connector. In this method, however, the calculation of the center of the inscribed virtual circle may have variation, and appropriate evaluation may not be achieved.

An object of the present invention is to provide an optical connector that is easy to evaluate if it is manufactured as designed. In addition, another object of the present invention is to provide an optical module including the optical connector. In addition, another object of the present invention is to provide a method for evaluating the optical connector.

### Solution to Problem

An optical connector according to an embodiment of the present invention includes: a light transmissive wall including a first surface and a second surface disposed on a rear side of the first surface; a holding part configured to hold an optical transmission member such that an end surface of the optical transmission member faces the second surface; a plurality of first optical surfaces disposed along an X direction in the first surface; a plurality of grooves disposed at the holding part and extended away from the second surface in a direction opposite to the first surface; and a plurality of X-direction reference marks. Each of the plurality of X-direction reference marks is disposed on a first virtual plane that includes a valley line of a groove of any of the plurality of grooves and is perpendicular to the X direction.

An optical module according to an embodiment of the present invention includes: the above-described optical connector; and an optical transmission member held at the holding part of the optical connector.

A method for evaluating the optical connector according to an embodiment of the present invention includes: evaluating the optical connector based on a positional relationship between each of the plurality of X-direction reference marks and a center of each of the plurality of the first optical surfaces.

A method for evaluating the optical connector according to an embodiment of the present invention includes: evaluating the optical connector based on a positional relationship between the Y-direction reference mark and a center of each of the plurality of the first optical surfaces.

### Advantageous Effects of Invention

According to the present invention, it is possible to provide an optical connector that is easy to evaluate if it is manufactured as designed. In addition, according to the present invention, it is possible to provide an optical module including the optical connector. In addition, according to the present invention, it is possible to provide a method for evaluating the optical connector.

### BRIEF DESCRIPTION OF DRAWINGS

FIG. 1 is a sectional view of an optical module according to an embodiment;

FIG. 2 is a perspective view of an optical connector according to the embodiment;

FIG. 3A is a plan view of the optical connector according to the embodiment, and FIG. 3B is a bottom view;

FIG. 4A is a front view of the optical connector according to the embodiment, FIG. 4B is a rear view, FIG. 4C is a left side view, and FIG. 4D is a right side view; and

FIG. 5A is a sectional view taken along line A-A of FIG. 4B, FIG. 5B is a partially enlarged view of FIG. 4B, and FIG. 5C is a partially enlarged view of FIG. 4B.

### DESCRIPTION OF EMBODIMENTS

### Configuration of Optical Module

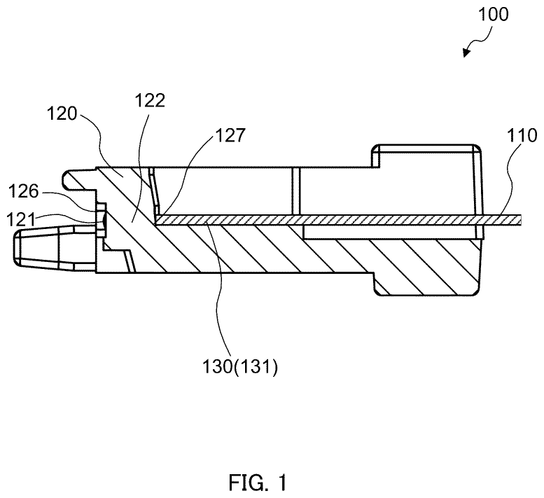

FIG. 1 is a sectional view illustrating a configuration of optical module 100 according to an embodiment of the present invention.

As illustrated in FIG. 1, optical module 100 according to the present embodiment includes a plurality of optical transmission members 110, and optical connector 120. Optical module 100 is used in the state where the plurality of optical transmission members 110 is connected to optical connector 120. Optical module 100 is used in a pair (paired). The same optical connectors 120 are connected to each other in the state where one optical module 100 holding the plurality of optical transmission members 110 is reversed upside down with respect to the other optical module 100 holding the plurality of optical transmission members 110, and the plurality of optical transmission members 110 of one optical module 100 and the other optical module 100 are optically coupled with each other. Note that optical module 100 can be used together with a housing, a spring clamp structure part and the like (omitted in the drawing). Note that in the present embodiment, optical connectors 120 are connected by reversing them in an upside down manner, but the optical connectors may be connected with each other without reversing them in an upside down manner depending on the configuration of the optical connector.

The type of optical transmission member 110 is not limited. Examples of the type of optical transmission member 110 include optical fibers and optical waveguides. The number of optical transmission members 110 is not limited as long as a plurality of optical transmission members 110 are provided. Optical transmission member 110 is disposed at holding part 130 of optical connector 120. Optical transmission member 110 is held such that its end surface faces second surface 127. In the present embodiment, optical transmission member 110 is an optical fiber. In addition, the optical fiber may be of a single mode type, or a multiple mode type. Optical transmission member 110 serving as an optical waveguide and a silicon substrate may make up a photonic integrated circuit (PIC). The position of optical transmission member 110 is not limited, but optical transmission member 110 may protrude upward from a recess formed in the top surface of the photonic integrated circuit, or may be embedded in the photonic integrated circuit, for example.

### Configuration of Optical Connector

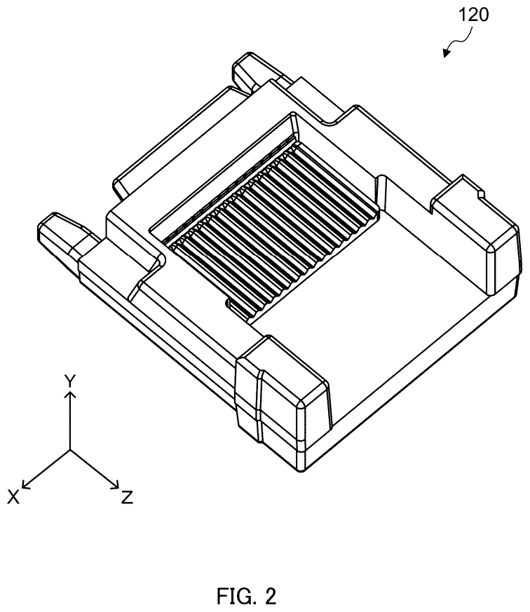

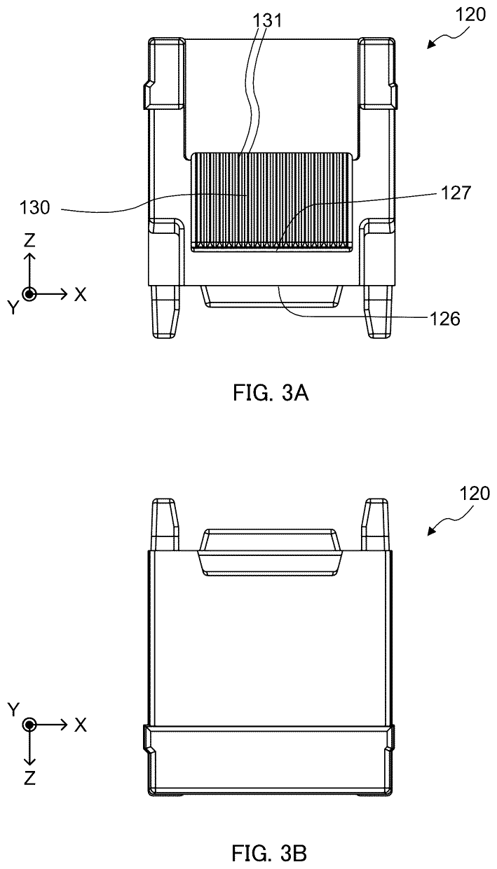

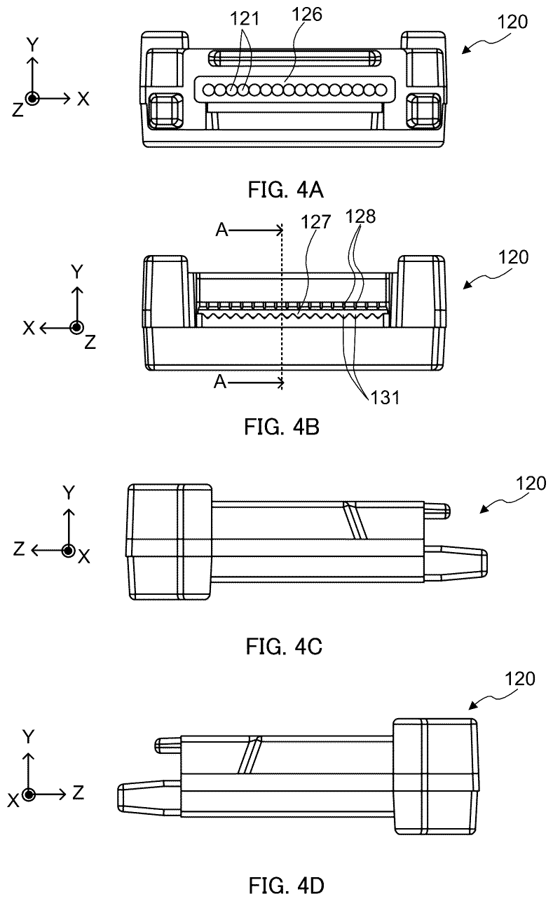

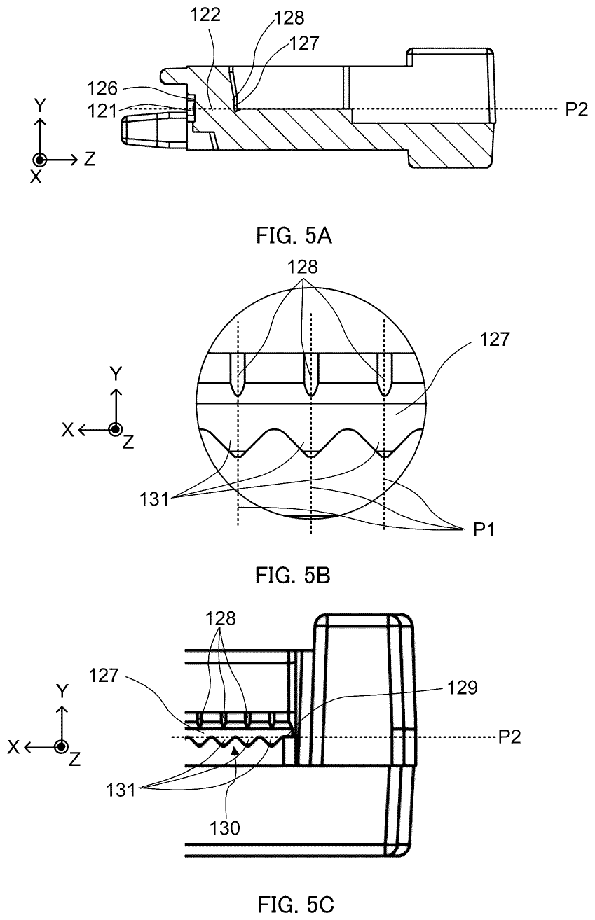

FIG. 2 is a perspective view of optical connector 120 according to the embodiment of the present invention. FIG. 3A is a plan view of optical connector 120 according to the embodiment of the present invention, and FIG. 3B is a bottom view. FIG. 4A is a front view of optical connector 120 according to the embodiment of the present invention, FIG. 4B is a rear view, FIG. 4C is a left side view, and FIG. 4D is a right side view. In addition, FIG. 5A is a sectional view taken along line A-A of FIG. 4B, FIG. 5B is a partially enlarged view of FIG. 4B, and FIG. 5C is a partially enlarged view of FIG. 4B.

Note that in the following description, as illustrated in FIG. 4A, the direction in which first optical surface 121 is arranged is referred to as the “X direction”. The “X direction” is the direction along the bottom surface of optical connector 120 in front view and back view of optical connector 120 (see FIGS. 4A and 4B). In addition, the direction orthogonal to the X direction is the “Y direction”. The “Y direction” is the direction (height direction) along the side surface in front view and back view of the optical connector. In addition, the “Z direction” is the direction orthogonal to the “X direction” and the “Y direction”. The “Z direction” is the direction along the bottom surface of optical connector 120 in side view of optical connector 120.

As illustrated in FIGS. 1 to 5C, optical connector 120 is a substantially cuboid shape member. Optical connector 120 includes light transmissive wall 122, holding part 130, a plurality of first optical surfaces 121, a plurality of X-direction reference marks 128, and Y-direction reference mark 129.

As illustrated in FIG. 5A, light transmissive wall 122 includes first surface 126, and second surface 127 disposed on the rear side of first surface 126. Light transmissive wall 122 is a wall that transmits light from optical transmission member 110 or light to optical transmission member 110 (see FIG. 1). More specifically, in light transmissive wall 122, light from optical transmission member 110 is transmitted through second surface 127 and first surface 126 in this order, and light to optical transmission member 110 is transmitted through first surface 126 and second surface 127 in this order (see FIG. 1).

As illustrated in FIG. 5A, first surface 126 is a surface disposed on the rear side of second surface 127 in light transmissive wall 122. For example, when optical connector 120 is connected to a device such as another optical connector or an external device, first surface 126 faces the device. Preferably, first surface 126 includes first optical surface 121 for controlling the distribution of light to be transmitted.

First optical surface 121 can control light from optical transmission member 110 or light to optical transmission member 110. In the present embodiment, as illustrated in FIG. 4A, first optical surface 121 is disposed along the X direction.

The first optical surface needs only to be a curved surface that can refract light, more specifically is a convex lens, for example. The shape of the first optical surface is not limited, but examples of the shape include a circular shape and an elliptical shape.

In the present embodiment, the plurality of first optical surfaces 121 is disposed in a line along the X direction in a manner corresponding to the plurality of respective optical transmission members 110. In the present embodiment, the plurality of first optical surfaces 121 is disposed between the two first optical surfaces 121 adjacent to each other with no gap therebetween. It should be noted that the plurality of first optical surfaces 121 may be disposed separately from each other.

The number of the first optical surfaces 121 is not limited as long as a plurality of first optical surfaces 121 is provided. In the present embodiment, sixteen first optical surfaces 121 are provided.

As illustrated in FIG. 5A, second surface 127 is a surface disposed on the rear side of first surface 126 in light transmissive wall 122 so as to directly face the end surface of optical transmission member 110 (see FIG. 1). In the present embodiment, the end surface of optical transmission member 110 makes contact with second surface 127. In addition, in the present embodiment, second surface 127 is a flat surface, and the flat surface is parallel to a plane composed of the X direction and the Y direction, and is longer in the X direction (see FIG. 4B).

As illustrated in FIG. 1, holding part 130 is a part that holds optical transmission member 110 so as to face second surface 127. In the present embodiment, as illustrated in FIG. 3A, holding part 130 includes a plurality of grooves 131 for positioning optical transmission member 110, and optical transmission member 110 is disposed along grooves 131.

As illustrated in FIG. 3A, grooves 131 are linearly extended away from second surface 127 in the direction opposite to first surface 126. More specifically, in the present embodiment, grooves 131 extend perpendicular to second surface 127 in plan view of optical connector 120.

The shapes of grooves 131 are not limited as long as optical transmission member 110 can be held. Examples of grooves 131 include V grooves and U grooves. The “V groove” is a groove composed of two surfaces, with a V-shape in a cross section perpendicular to the extending direction of the groove. The connecting portion of the two surfaces may be chamfered (subjected to a process of rounding the corner). The “U groove” is a groove composed of a single curved surface, and has an arc-like shape in a cross section perpendicular to the extending direction of the groove.

The number of grooves 131 is not limited as long as a plurality of grooves 131 is provided, and is the same as the number of the first optical surfaces 121, for example. In the present embodiment, sixteen grooves 131 are provided.

The plurality of X-direction reference marks 128 is disposed in a manner corresponding to the plurality of first optical surfaces 121 and the plurality of grooves 131. X-direction reference marks 128 are reference marks for evaluating whether the corresponding grooves 131 are manufactured such that the center of optical transmission member 110 can be aligned with the corresponding first optical surface 121. As illustrated in FIGS. 5B and 5C, each X-direction reference mark 128 is disposed in a first virtual plane P1 that includes the valley line of groove 131 and is perpendicular to the X direction. Note that the “valley line” is a line that extends to connect the deepest part of groove 131 in the Z direction. Note that in the case where the deepest part cannot be uniquely defined, the intersection of the bottom portion of groove 131 and the symmetric line (symmetry axis) of groove 131 as viewed in a lateral cross section is set as the deepest part, and the “valley line” is a line that extends to connect the intersection in the Z direction.

It is expected in optical module 100 that the center of optical transmission member 110 disposed at groove 131 is located on the above-described first virtual plane P1, and further the center of the first optical surface 121 is also located on the first virtual plane P1 (see FIG. 1). Specifically, it is considered that a state where they coincide with each other in the X direction is a condition for achieving ideal optical coupling. Therefore, whether optical connector 120 is manufactured as desired can be evaluated by evaluating the positional relationship between X-direction reference mark 128 formed to be disposed on the first virtual plane P1 and the center of the first optical surface 121.

The position of X-direction reference marks 128 is not limited as long as it is on the first virtual plane P1. It suffices that X-direction reference mark 128 is disposed on first surface 126 or second surface 127 on the first virtual plane P1, for example. In the present embodiment, X-direction reference mark 128 is disposed on second surface 127 (see FIG. 5A). By providing X-direction reference marks 128 on second surface 127 when obtaining the optical connector of the present embodiment through injection molding, both groove 131 and the X-direction reference mark 128 can be processed in a single piece where grooves 131 is to be formed. Specifically, since both grooves 131 and X-direction reference marks 128 can be formed without detaching the piece attached to the processing stage, the reference mark can be highly accurately provided. If X-direction reference mark 128 is formed on first surface 126 side, then the reference mark should be processed in another piece by a step different from the groove processing, and as a result, the accuracy of the present embodiment cannot be obtained due to the accumulation of processing errors, incorporation errors in metal mold and the like.

In addition, preferably X-direction reference mark 128 is disposed at first surface 126 or second surface 127 so as to prevent interference with light transmitted through light transmissive wall 122. In the present embodiment, X-direction reference mark 128 is disposed in a portion other than the portion where optical transmission member 110 is disposed. In addition, preferably, X-direction reference mark 128 is disposed at first surface 126 or second surface 127 such that X-direction reference mark 128 and the corresponding first optical surface 121 are simultaneously viewed when optical connector 120 is viewed in the Z direction. More specifically, in the present embodiment, as illustrated in FIG. 5B, X-direction reference mark 128 is disposed above the position where optical transmission member 110 is disposed in second surface 127.

The shape of X-direction reference mark 128 is not limited as long as the position of the first virtual plane P1 can be determined. In addition, examples of the shape of X-direction reference mark 128 include shapes of protrusion, recess, groove and the like. In the present embodiment, as illustrated in FIGS. 5B and 5C, X-direction reference mark 128 is a protrusion, disposed on second surface 127, with a tapered shape whose end portion coincides with the first virtual plane P1.

The number of X-direction reference marks 128 is not limited, but is normally the same as the number of the first optical surfaces 121 or grooves 131. In the present embodiment, sixteen X-direction reference marks 128 are provided.

Y-direction reference mark 129 is disposed on second virtual plane P2 that is orthogonal to second surface 127 and includes the center of the first optical surface 121, in a portion other than the region where the plurality of grooves 131 is disposed in holding part 130 when second virtual plane P2 is viewed in plan view in a see-through manner (see FIGS. 5A and 5C). Y-direction reference mark 129 is a reference mark for evaluation if optical connector 120 is manufactured as desired such that optical transmission member 110 can be appropriately installed in the Y direction.

More specifically, it is expected that the center of optical transmission member 110 disposed at groove 131 is located on the above-mentioned second virtual plane P2. Specifically, coincidence of the center of the first optical surface 121 and the center of optical transmission member 110 in the Y direction is considered to be a condition for achieving ideal optical coupling. Therefore, whether optical connector 120 is manufactured as desired can be evaluated with Y-direction reference mark 129.

The position and configuration of Y-direction reference mark 129 are not limited as long as it is disposed on second virtual plane P2 to serve as a reference in the Y direction. For example, Y-direction reference mark 129 may be a protrusion, recess, groove or the like disposed at first surface 126 or second surface 127. In addition, Y-direction reference mark 129 may be a flat surface disposed at holding part 130 as illustrated in FIG. 5C. Preferably, Y-direction reference mark 129 is disposed at first surface 126, second surface 127 or holding part 130 such that Y-direction reference mark 129 and first optical surface 121 corresponding to it are simultaneously viewed when optical connector 120 is viewed in the Z direction. In the present embodiment, Y-direction reference mark 129 is a flat surface that is disposed on second virtual plane P2, in a portion other than the region where the plurality of grooves 131 is disposed in holding part 130. More specifically, Y-direction reference mark 129 is disposed outside the region where the plurality of grooves 131 is disposed in holding part 130. As illustrated in FIG. 5C, even Y-direction reference mark 129 formed as a flat surface functions as the Y-direction reference mark because the reference of the Y direction can be recognized when viewed from the Z direction.

Optical connector 120 according to the present embodiment may include the above-described plurality of X-direction reference marks 128, and may optionally include the above-described Y-direction reference mark 129.

Evaluation Method A method for evaluating an optical connector including X-direction reference mark 128 is described below.

With the above-mentioned optical connector 120, optical connector 120 can be evaluated based on the positional relationship between each of the plurality of X-direction reference marks 128 and the center of each of the plurality of first optical surfaces 121.

More specifically, it suffices to evaluate the positional relationship between the center of the first optical surface 121 and the extension (a line that coincides with the first virtual plane P1) that is derived from X-direction reference mark 128 as viewed from the Z direction. Ideally, the center of the first optical surface 121 is located on the extension. Optical connector 120 can be evaluated by evaluating the shift from this ideal state.

A method for evaluating optical connector 120 including Y-direction reference mark 129 is described below.

With the above-mentioned optical connector 120, optical connector 120 can be evaluated based on the positional relationship between Y-direction reference mark 129 and the center of the first optical surface 121.

More specifically, it suffices to evaluate the positional relationship between the center of the first optical surface 121 and an extension (a line that coincides with second virtual plane P2) derived from Y-direction reference mark 129 as viewed from the Z direction. Ideally, the center of the first optical surface 121 is located on the extension. Optical connector 120 can be evaluated by evaluating the shift from this ideal state.

Note that the evaluation method using X-direction reference marks 128 and the evaluation method using Y-direction reference mark 129 can be combined. In this case, ideally, the intersection of the extension derived from X-direction reference marks 128 and the extension derived from Y-direction reference mark 129, and the center of the first optical surface 121 coincide with each other. Therefore, optical connector 120 can be evaluated by evaluating the shift between the intersection and the center.

Effects Optical connector 120 and the evaluation method according to the present embodiment include the plurality of X-direction reference marks 128 and optionally include Y-direction reference mark 129, and thus whether optical connector 120 is manufactured as designed can be easily evaluated.

This application is entitled to and claims the benefit of Japanese Patent Application No. 2022-019615 filed on Feb. 10, 2022, the disclosure each of which including the specification, drawings and abstract is incorporated herein by reference in its entirety.

### INDUSTRIAL APPLICABILITY

The optical connector according to the present invention enables evaluation if it is manufactured with high accuracy, and is therefore suitable for highly accurate optical communications using optical transmission members.

### REFERENCE SIGNS LIST

100 Optical module
110 Optical transmission member
120 Optical connector
121 The first optical surface
122 Light transmissive wall
126 First surface
127 Second surface
128 X-direction reference mark
129 Y-direction reference mark
130 Holding part
131 Groove
P1 First virtual plane
P2 Second virtual plane

1. An optical connector, comprising:
a light transmissive wall including a first surface and a second surface disposed on a rear side of the first surface;
a holding part configured to hold an optical transmission member such that an end surface of the optical transmission member faces the second surface;
a plurality of first optical surfaces disposed along an X direction in the first surface;
a plurality of grooves disposed at the holding part and extended away from the second surface in a direction opposite to the first surface; and
a plurality of X-direction reference marks,
wherein each of the plurality of X-direction reference marks is disposed on a first virtual plane that includes a valley line of a groove of any of the plurality of grooves and is perpendicular to the X direction.

2. The optical connector according to claim 1, wherein a Y-direction reference mark is disposed on a second virtual plane that includes a center of the plurality of the first optical surfaces and is orthogonal to the second surface, in a portion other than a region where the plurality of groove is disposed in the holding part when the second virtual plane is viewed in plan view in a see-through manner.

3. The optical connector according to claim 1, wherein the X-direction reference mark is disposed on the second surface.

4. An optical module, comprising:
the optical connector according to claim 1; and
an optical transmission member held at the holding part of the optical connector.

5. A method for evaluating the optical connector according to claim 1, the method comprising:
evaluating the optical connector based on a positional relationship between each of the plurality of X-direction reference marks and a center of each of the plurality of the first optical surfaces.

6. A method for evaluating the optical connector according to claim 2, the method comprising:
evaluating the optical connector based on a positional relationship between the Y-direction reference mark and a center of each of the plurality of the first optical surfaces.

7. A method for evaluating the optical connector according to claim 2, the method comprising:
evaluating the optical connector based on a positional relationship between each of the plurality of X-direction reference marks and the Y-direction reference mark, and a center of each of the plurality of the first optical surfaces.
